(19) United States
(12) Patent Application Publication
(10) Pub. No.: US 2026/0171783 A1
(43) Pub. Date: Jun. 18, 2026

(54) AUTONOMOUS SYSTEM SEQUENCING OF DISCRETE REGULATORS WITH CASCADED INTERFACE SIGNAL

(71) Applicant: Renesas Electronics America Inc., Milpitas, CA (US)

(72) Inventors: Nattorn PONGRATANANUKUL, San Jose, CA (US); Christopher John MILLER, Harlow (GB); Vinod Aravindakshan LALITHAMBIKA, Harlow (GB); Michael Marshall RENAULT, Medway, MA (US)

(73) Assignee: Renesas Electronics America Inc., Milpitas, CA (US)

(21) Appl. No.: 18/978,128

(22) Filed: Dec. 12, 2024

(51) Int. Cl. H02H 7/12; H02M 1/00; H02M 3/156

(52) U.S. Cl. CPC H02H 7/1213; H02M 1/007; H02M 3/156

(57) ABSTRACT

Systems and methods for operating one or more power regulators are described. A power regulator can include an enable pin configured to receive an enable signal for enabling generation of an output voltage. The power regulator can further include a power good pin configured to output a power good signal indicating a status of the output voltage. The power regulator can further include a circuit configured to detect a presence of a fault condition. The circuit can be further configured to, in response to detecting the fault condition, de-assert the power good pin to disable a downstream device and de-assert the enable pin to disable an upstream device.

### BACKGROUND

The present disclosure relates in general to semiconductor devices. More specifically, the present disclosure relates to systems and methods for autonomous system sequencing of discrete regulators or power rails with cascaded interface signal, without additional supervisory elements.

Discrete power rails with cascaded signaling to supply different components can be implemented by a plurality of discrete voltage regulators arranged in series. Each power rail or voltage regulator provides a specific voltage that may be required by various parts of a circuit, like analog and digital components, which may need different voltage levels for optimal performance. The cascaded signaling can be realized by a hierarchy where activation of a discrete voltage regulator can be dependent on activation of other discrete voltage regulators.

### SUMMARY

In one embodiment, an apparatus implementing a power regulator is generally described. The apparatus can include an enable pin configured to receive an enable signal for enabling generation of an output voltage. The apparatus can further include a power good pin configured to output a power good signal indicating a status of the output voltage. The apparatus can further include a circuit configured to detect a presence of a fault condition. The circuit can further include, in response to detecting the fault condition, de-assert the power good pin to disable a downstream device and de-assert the enable pin to disable an upstream device.

In one embodiment, a system for power regulation is generally described. The system can include a plurality of voltage regulators including at least an upstream voltage regulator, a specific voltage regulator, and a downstream voltage regulator. The specific voltage regulator can include an enable pin configured to receive an enable signal from the upstream voltage regulator for enabling the specific voltage regulator. The specific voltage regulator can further include a power good pin configured to output a power good signal to control an enable pin of the downstream voltage regulator. The specific voltage regulator can further include a circuit configured to detect a presence of a fault condition in the specific voltage regulator. The circuit can be further configured to, in response to detecting the fault condition, de-assert the power good pin to disable the downstream voltage regulator and de-assert the enable pin to disable the upstream voltage regulator.

In one embodiment, a system for power regulation is generally described. The system can include a plurality of voltage regulators and a controller. The controller can be configured to enable a first voltage regulator among the plurality of voltage regulators. The plurality of voltage regulators can include at least the first voltage regulator and a second voltage regulator. The first voltage regulator can include a first enable pin configured to receive an enable signal from the controller for enabling the first voltage regulator. The first voltage regulator can further include a first power good pin configured to output a first power good signal to control a second enable pin of the second voltage regulator. The first voltage regulator can further include a first circuit configured to configure the first power good pin as an input pin for detecting de-assertion of the second enable pin of the second voltage regulator. The second voltage regulator can include a second enable pin configured to receive the first power good signal from the first power good pin. The second voltage regulator can further include a second power good pin configured to output a second power good signal to control a downstream voltage regulator among the plurality of voltage regulators. The second voltage regulator can further include a second circuit configured to configure the second power good pin as an input pin for detecting de-assertion of an enable pin of the downstream voltage regulator. The second circuit can be further configured to detect a presence of a fault condition in the second voltage regulator. The second circuit can be further configured to, in response to detecting the fault condition, de-assert the second power good pin to disable the downstream voltage regulator and de-assert the second enable pin to disable the first voltage regulator.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a diagram showing an example system that can implement autonomous system sequencing of discrete regulators with cascaded interface signal in one embodiment.

FIG. 2 is a diagram showing an example implementation of autonomous system sequencing of discrete regulators with cascaded interface signal in one embodiment.

FIG. 3A is a diagram showing example signals when an upstream shut down function is disabled in one embodiment.

FIG. 3B is a diagram showing example signals when the upstream shut down function is enabled in one embodiment.

FIG. 4 is a diagram showing example signals of an implementation of autonomous system sequencing of discrete regulators with cascaded interface signal in one embodiment.

FIG. 5 is a diagram showing example signals of another implementation of autonomous system sequencing of discrete regulators with cascaded interface signal in one embodiment.

FIG. 6 is a flowchart of an example process that can implement autonomous system sequencing of discrete regulators with cascaded interface signal in one embodiment.

### DETAILED DESCRIPTION

In the following description, numerous specific details are set forth, such as particular structures, components, materials, dimensions, processing steps and techniques, to provide an understanding of the various embodiments of the present application. However, it will be appreciated by one of ordinary skill in the art that the various embodiments of the present application may be practiced without these specific details. In other instances, various structures or processing steps have not been described in detail to avoid obscuring the present application.

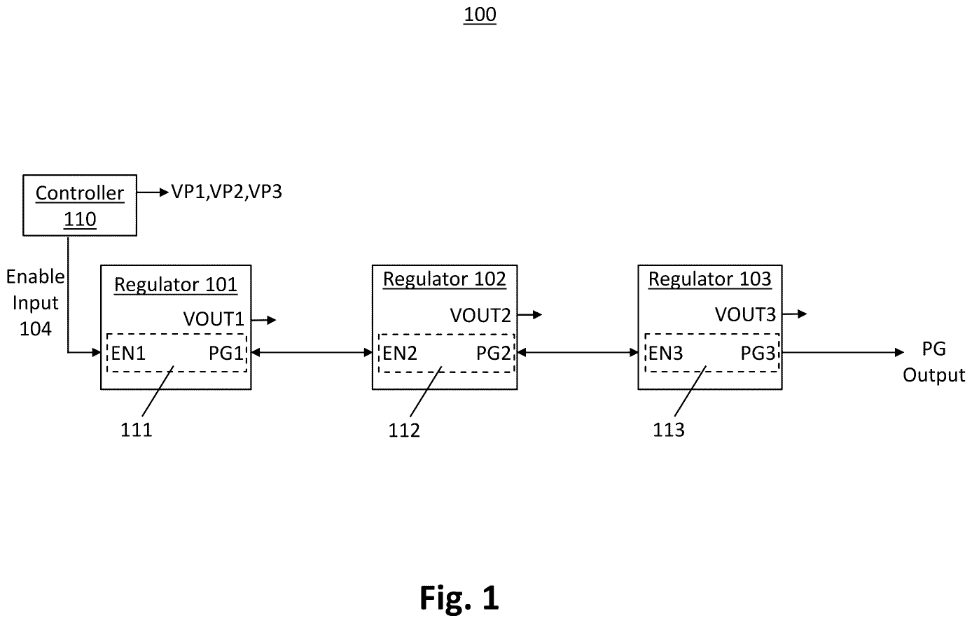

FIG. 1 is a diagram showing an example system 100 that can implement autonomous system sequencing of discrete regulators with cascaded interface signal in one embodiment. System 100 can be a power regulation system including a plurality of voltage regulators connected in a cascade arrangement. Each one of the plurality of voltage regulators can be configured to generate power having individual amount of voltage to support different loads. System 100 can be implemented in, for example, power management integrated circuit (PMIC).

In the example shown in FIG. 1, system 100 can include a controller 110 and the plurality of voltage regulators labeled as regulators 101, 102, 103. Regulators 101, 102, 103 can output power having voltages VOUT1, VOUT2, VOUT3, respectively. Controller 110 can be configured to control various aspects of regulators 101, 102, 103. Controller 110 can be, for example, a microcontroller, an analog controller, or dedicated analog hardware. Controller 110 can further include various electronic components, such as processors, logic circuits, digital to analog converters (DACs), comparators, mixers, amplifiers, and various electronic components. System 100 can include additional regulators after regulator 103 but three regulators are shown in FIG. 1 for simplicity. The cascade arrangement of regulators 101, 102, 103 can have a hierarchy. In FIG. 1, regulator 101 is considered as a first regulator in the hierarchy and regulator 103 is considered as the last regulator in the hierarchy. As described herein, the term “upstream” can refer to regulators that are positioned before a regulator in the hierarchy and the term “downstream” can refer to regulators that are positioned after a regulator in the hierarchy.

Each one of regulators 101, 102, 103 can be enabled or disabled by a signal (e.g., a voltage signal) received at an enable pin. Regulator 101 can be enabled or disabled by an enable input 104 being received at an enable pin EN1. Controller 110 can be configured to generate enable input 104. By way of example, the enable input 104 having a high voltage or logic high can enable regulator 101, and a low voltage or logic low can disable regulator 101. When regulator 101 is enabled, regulator 101 can generate power, output the power at a VOUT1 pin, and pull up a power good pin PG1 such that a high voltage can be outputted from the pin PG1. In the cascade arrangement shown in FIG. 1, the pin PG1 can be connected to the enable pin EN2 of regulator 102. When PG1 outputs a high voltage, the high voltage can enable regulator 102. When PG1 is pulled down and outputs a low voltage, the low voltage can disable regulator 102.

When regulator 102 is enabled, regulator 102 can generate power, output the power at a VOUT2 pin, and pull up a power good pin PG2 such that a high voltage can be outputted from the PG2 pin. In the cascade arrangement shown in FIG. 1, the PG2 pin can be connected to the enable pin EN3 of regulator 103. When PG2 outputs a high voltage, the high voltage can enable regulator 103. When PG2 is pulled down and outputs a low voltage, the low voltage can disable regulator 103.

When regulator 103 is enabled, regulator 103 can generate power, output the power at a VOUT3 pin, and pull up a power good pin PG3 such that a high voltage can be outputted from the PG3 pin. In the cascade arrangement shown in FIG. 1, the PG3 pin can be connected to an enable pin of a next regulator. In some embodiments, the outputs from PG1, PG2, PG3 can be fed back to controller 110 such that controller 110 can track which regulators are enabled. Further, voltages and/or current at the VOUT1, VOUT2, VOUT3 pins can be sensed or measured, and provided to controller 110, such that controller 110 can use these measurements and the fed back signals from the power good pins to perform fault detection of individual regulators along with hierarchy.

In an aspect, sequencing behavior of discrete power rails with cascaded signaling can have constraints that are dependent on how the power rails'signaling are connected. When used in system design such as for system-on-a-chip (SoC) and CPU computing loads where power rails sequencing is critical, additional mechanism is needed to achieve more flexible power off sequencing and fault handling. One of the conventional approaches for realizing power sequencing of discrete regulators is by cascading upstream power good (PG) output signal to downstream's enable (EN) input pin, as shown in FIG. 1. The start-up sequence is configured by chaining PG-to-EN in the order of desired power up sequence. Due to the connection, the shutdown sequence is limited to disabling rails starting from the rail receiving the disabled signal followed by sequential rails downstream which is the same order as the start-up sequence. Typically fault in a downstream regulator is also limited to shut down the rail with fault and rails further downstream, while upstream rails stay running unaware of fault downstream. For example, using the example in FIG. 1, if a fault occurs at regulator 102, then the conventional approach is that regulator 102 will be disabled by pulling PG2 down which disables regulator 103, but controller 110 will have to disable regulator 101. Such power solutions have limited sequencing off capability compared to power management integrated circuit (PMIC) or system with a shared signaling bus due to connection and lack of synchronization signal.

To be described herein, the present disclosure describes circuit implementations and mechanisms to use existing cascaded PG-to-EN connections to realize a sequencing turn on and turn off scheme, to distribute fault information both upstream and downstream, and to realize automatic shutdown and restart of the entire system of regulators without external supervisor element. Regulators 101, 102, 103 can include circuits 111, 112, 113, respectively, that can allow the enable pins and power good pins to function as input or output pins under various signal events. Note that in conventional systems, the enable pins are typically input pins and the power good pins are typically output pins. The configuration of the enable pins and power good pins as input or output pins can allow a regulator to disable upstream devices in addition to downstream devices. Also, the configuration of the enable pins and power good pins using circuits 111, 112, 113 can allow system 100 to automatically shut down and restart without external supervisory element, such as controller 110.

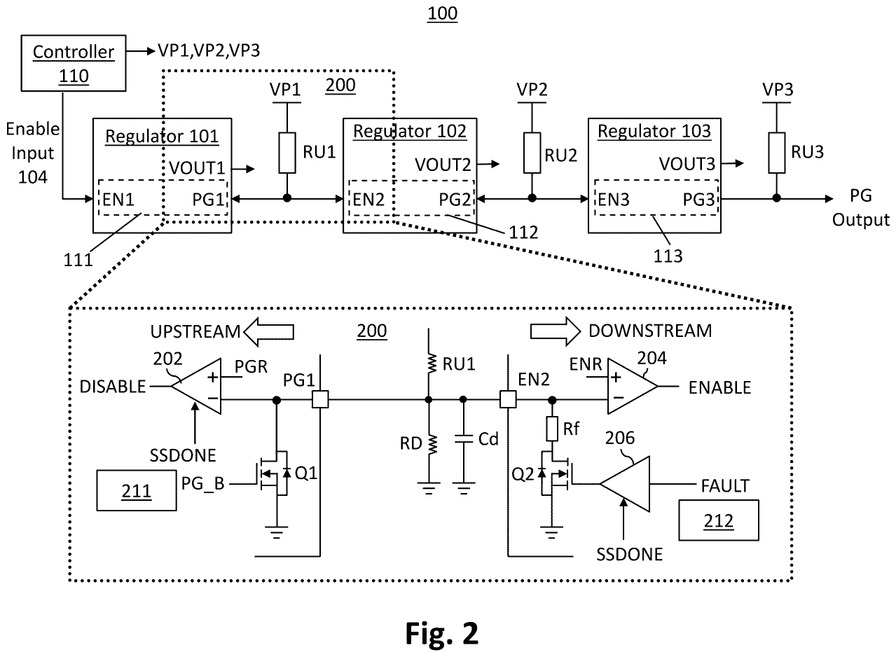

FIG. 2 is a diagram showing an example implementation of autonomous system sequencing of discrete regulators with cascaded interface signal in one embodiment. Descriptions of FIG. 2 can reference components shown in FIG. 1. In an embodiment shown in FIG. 2, a portion of circuit 111 in regulator 101 and a portion of circuit 112 in regulator 102 can form a circuit 200 that implements a bi-directional signal interface between the pin PG1 of regulator 101 and the pin EN2 in regulator 102. The bi-directional signal interface implemented by circuit 200 can also be applicable to other pairs of consecutive regulators, such as regulators 102, 103. A network of components including a pull-up resistor RU1, a pull-down resistor RD1 and a capacitor Cd can be included in circuit 200 and connected between the PG1 and pin EN2s. Capacitor Cd can be a delay capacitor for adding a delay between the PG pin and the EN pin to provide ample time to start up the downstream regulator. For example, the capacitor Cd between regulators 101, 102 in circuit 200 can delay signals between regulators 101, 102 during startup of regulator 102.

The portion of circuit 111, that is part of circuit 200, can include a comparator 202 and a switch Q1. Switch Q1 can be switching element such as a metal-oxide-semiconductor field-effect transistor (MOSFET) or an insulated-gate bipolar transistor (IGBT). An inverting input of comparator 202 can be connected to the pin PG1. A non-inverting input of comparator 202 can be connected to a signal PGR. The signal PGR can be a predefined reference voltage that can be greater than or equal to a voltage level for asserting the pin PG1 (e.g., pulling to high). A drain terminal of switch Q1 can be connected to a node between the inverting input of comparator 202 and the PG pin. A source terminal of switch Q1 can be grounded. A gate of switch Q1 can be driven by an internal signal PG_B generated by a controller 211 of regulator 101.

In one embodiment, regulator 101 can go through a soft-start where VOUT1 can be ramped up to a predefined output voltage of regulator 101. Regulator 101 can assert the internal signal PG_B during the soft-start to turn on switch Q1 such that the pin PG1 can be shorted to ground, which prevents the pin PG1 from being asserted before soft-start is done. When VOUT1 reaches the predefined output voltage of regulator 101, regulator 101 can de-assert PG_B (e.g., pulling down to low) to turn off Q1 such that the pin PG1 can be asserted. Assertion of the pin PG1 can enable the downstream regulator, which is regulator 102. Regulators 102, 103 can also include identical circuitry configured to assert and de-assert their respective internal signal PG_B.

Also, when VOUT1 reaches the predefined output voltage of regulator 101, regulator 101 can generate an internal signal SSDONE indicating soft-start is completed. Before completing the soft-start, SSDONE can be de-asserted to keep comparator 202 disabled. When soft-start is completed, regulator 101 can assert SSDONE and enable comparator 202. When comparator 202 is enabled, the inverting input of comparator 202 can draw current from the pin PG1 such that the pin PG1 can be configured as an input pin. When the voltage at the pin PG1 is below the reference PGR, comparator 202 can output a disable signal (“DISABLE”) to disable the enable pin EN1 of regulator 101. Controller 110 can generate and provide a pull up voltage VP1 to supply current to the pin PG1 to ensure that the voltage at the pin PG1 is greater than the reference PGR. By ensuring that the voltage at the pin PG1 is greater than or equal to the reference PGR, the EN1 pin of regulator 101 will not be inadvertently de-asserted to disable regulator 101 when the pin PG1 is still asserted. If PG1 is pulled down, such as by de-assertion of the pin EN2 of regulator 102, the voltage at PG1 can fall below PGR even if controller 110 is supplying pull up voltage VP1. When the voltage at PG1 falls below PGR, comparator 202 can output the DISABLE signal to pull down the EN1 pin to disable regulator 101. Hence, de-assertion of EN2 can disable an upstream device, which is regulator 101. In one embodiment, the pull up voltage VP1 can be less than PGR such that when PG1 is de-asserted, the voltage at the inverting input of comparator 202 (e.g., VP1) is less than PGR to trigger comparator 202 to output the DISABLE signal. In one embodiment, the controller 211 in regulator 101 can apply a delay (e.g., 100 microseconds (μs)) to assert SSDONE after soft-start is completed. The delay can provide ample time for controller 110 to provide pull up voltage VP1 to the PG pin of regulator 101 via pull up resistor RU1.

The portion of circuit 112, that is part of circuit 200, can include a comparator 204, an buffer 206, and a switch Q2. Switch Q2 can be switching element such as a MOSFET or an IGBT. An inverting input of comparator 204 can be connected to the pin EN2. A non-inverting input of comparator 204 can be connected to a signal ENR. The signal ENR can be a predefined reference voltage that can be greater than or equal to a voltage level for asserting the pin EN2. A drain terminal of switch Q2 can be connected to a node between the inverting input of comparator 204 and the pin EN2 via a fault resistor Rf. A source terminal of switch Q2 can be grounded. A gate of switch Q2 can be driven by an output of buffer 206.

In one embodiment, when the pin EN2 is asserted by assertion of pin PG1, the voltage at EN2 can reach the reference voltage ENR and comparator 204 can output an enable signal ENABLE to enable regulator 102. In one embodiment, when comparator 204 outputs the ENABLE signal, regulator 102 can undergo the soft-start process to ramp up VOUT2 to a predefined output voltage of regulator 102. When VOUT2 reaches the predefined output voltage of regulator 102, regulator 102 can generate the internal signal SSDONE indicating soft-start is completed.

Before completing the soft-start, SSDONE can be de-asserted to keep buffer 206 disabled. When SSDONE is de-asserted, the output voltage of buffer 206 remains at zero, hence disabling buffer 206 and maintaining Q2 in an off state. When soft-start is completed, regulator 102 can assert SSDONE to enable buffer 206 and to configured EN2 as an output pin. When buffer 206 is enabled, the input to buffer 206 can receive a fault signal FAULT. In one embodiment, when one or more fault condition occurs in regulator 102, a controller 212 in regulator 102 can generate the fault signal FAULT to indicate the occurrence of fault condition. Some examples of the fault condition can include, but not limited to, over current conditions, over voltage conditions, under voltage conditions, interruption to the output of VOUT, component damage, overheating (e.g., temperature too high), or other types of fault conditions. When the FAULT signal is asserted, buffer 206 can amplify the FAULT signal to a voltage level that is sufficient to turn on switch Q2. When switch Q2 is turned on, the enable pin EN2 can be pulled down to ground such that the pin EN2 is de-asserted. When the pin EN2 is de-asserted, the voltage at pin EN2 can be zero and comparator 204 will not output the ENABLE signal, hence disabling regulator 102. Also, the pin PG2 can be pulled down to zero in response to de-asserting EN2, and downstream devices, such as regulator 103, are also disabled. Further, when EN2 is de-asserted, pin PG1 of regulator 101 is also pulled down to trigger comparator 202 in regulator 101 to output DISABLE signal to disable regulator 101. Therefore, circuits 111, 112, 113 and circuit 200 in between consecutive pairs of regulators can allow a regulator to disable both downstream and upstream devices without using supervisory elements, such as controller 110, to disable upstream devices.

In one embodiment, each one of the regulators 101, 102, 103 can be configured as one out of three types of power rails. A first type of power rail is a slave non-power bad rail that cannot initiate its own enable pin (EN) low and can propagate error information to upstream devices. To configure a regulator as the first type of power rail, the switching of Q2 based on the FAULT signal can be disabled, such as by disconnecting signal paths between switch Q2 and buffer 206, or between buffer 206 and controller 212. When a regulator is configured as the first type of power rail, since the regulator cannot initiate its own EN pin low, the regulator can disable itself and downstream regulators when a fault condition occurs, but not upstream regulators.

A second type of power rail is a slave power bad rail that can initiate its own enable pin (EN) low and can propagate error information to upstream devices. For example, regulator 102 can be configured as the second type of power rail since controller 212 can use the FAULT signal to switch Q2 for pulling down EN2. When a regulator is configured as the second type of power rail, since the regulator can initiate its own EN pin low, the regulator can disable itself, downstream regulators, and upstream regulators, when a fault condition occurs, which results in a system-wide shut down.

A third type of power rail is a master rail that is the first power rail in the system that is enabled by a supervisory element, such as regulator 101 described herein that is enabled by controller 110. The third type of power rail can also initiate its own enable pin (EN) low. In one embodiment, controller 110 can store settings that identify regulators that are configured as first, second, or third type of power rails. By way of example, controller 110 can include storage devices, such as non-volatile memory, registers, programmable resistors, or the like, that can store data indicating whether each one of the regulators in system 100 are the first, second, or third type of power rails.

In one embodiment, when an upstream PG pin is pulled low by a downstream EN pin, the upstream device can shut down within a predefined delay time T_PG_LOW (e.g., 20 μs). In conventional systems where the slave regulators (e.g., regulator other than the first or master regulator) are not configured to shut down upstream devices, if there are N regulators, a fault condition at the master regulator can shut down all regulators within the time N×T_PG_LOW since the PG pins are being pulled down sequentially one by one. However, in these convention systems, if a fault condition occurs in a slave regulator, only the downstream regulators will be shut down and upstream devices need to rely on the supervisory element, such as controller 110, to detect a need to shut down upstream regulators, which utilizes time more than N×T_PG_LOW to perform the system-wide shut down. By configuring the slave devices to shut down upstream devices, as described herein, the slave devices can perform system-wide shut down using the time N×T_PG_LOW since external communication with controller 110 is no longer needed. Also, when a regulator is being disabled, the output voltage of the regulator can be maintained until a lapse of T_PG_LOW.

In one embodiment, when a regulator is configured as the second type of power rail, the regulator can keep its EN pin low until a lapse of a wait-before-retry time T_retry. In one embodiment, controllers (e.g., 211, 212, etc.) in the regulators of system 100 can implement a timer (e.g., software or hardware of combination of both) that can keep track of T_retry. When a fault condition occurs in a regulator (e.g., master or slave), the regulator pulls its EN pin low and the timer of T_retry can be triggered to start. If the T_retry period has elapsed, then the controller in the regulator can pull down the FAULT signal, which turns off the switch Q2 and its EN pin can become an input pin to wait for enabling by the PG pin of its upstream device. If the fault condition remains unresolved after T_retry lapsed, and the regulator is enabled again, the FAULT signal will be asserted again to turn on switch Q2 and pull the EN pin down.

In one embodiment, the T_retry time defined for a slave regulator (e.g., second type of power rail) can be less than the T_retry time defined for a master regulator (e.g., third type of power rail). By way of example, T_retry time defined for a slave regulator can be approximately 10 milliseconds (ms) and the T_retry time defined for a master regulator can be approximately 100 ms. In an aspect, If the T_retry time of the master is lower than the slave retry time then the master cannot enable the salve until the slave retry time has elapsed, which may not satisfy the startup sequence specifications. Therefore, it is preferable to have the T_retry for a slave regulator being less than the T_retry time for a master regulator.

In one embodiment, the voltage at the PG pins can be used by controller 110 and/or controllers in the regulators to determine the type of fault conditions and appropriate action to counter the fault conditions. For example, the lower the voltage at the PG pin, the more severe is the fault condition. In one embodiment, the different voltage levels at the PG pins can be dependent on the fault resistance in the downstream device. By way of example, as shown in FIG. 2, the resistance of Rf can impact the voltage being pulled down at EN2 and PG1. Controllers in the regulators can be configured to vary the resistance of Rf based on different fault conditions. If a relatively less severe fault occurs in regulator 102, controller 212 can increase the resistance of Rf to reduce the amount of voltage being pulled down at EN2 and PG1. If a relatively severe fault occurs in regulator 102, controller 212 can decrease the resistance of Rf to increase the amount of voltage being pulled down at EN2 and PG1. In one embodiment, the fault resistor Rf can be a variable resistor and controllers in the regulators can be configured to adjust the resistance of the variable resistor. In one embodiment, the fault resistor Rf can be a network of resistors and switches and controllers in the regulators can be configured to switch different resistors in the network to adjust the overall resistance of the Rf.

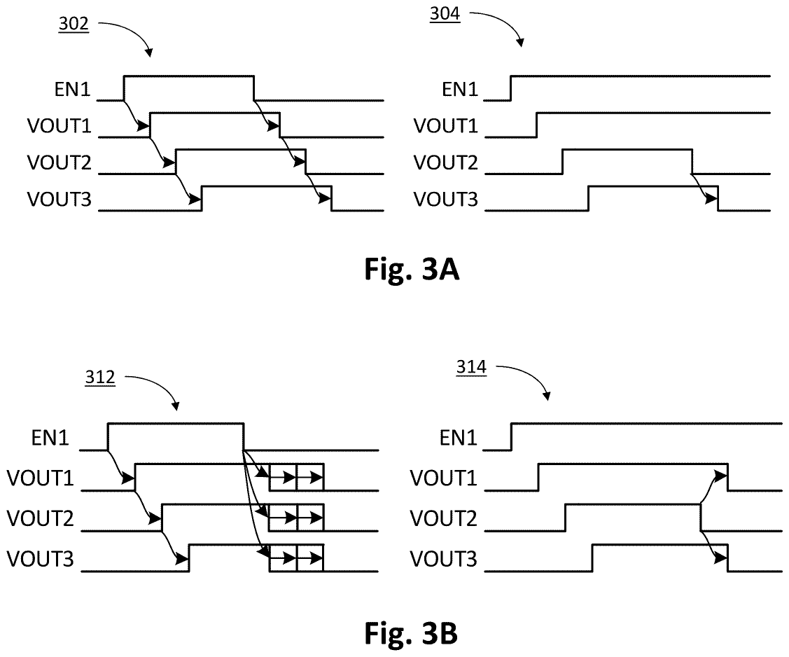

FIG. 3A is a diagram showing example signals when an upstream shut down function is

disabled in one embodiment. FIG. 3B is a diagram showing example signals when the upstream shut down function is enabled in one embodiment. Descriptions of FIG. 3A and FIG. 3B can reference components shown in FIG. 1 and FIG. 2. In an example 302 and example 304 shown in FIG. 3A, regulator 101 is configured as the third type of power rail (e.g., master regulator) and regulators 102, 103 are configured as the first type of power rails (e.g., unable to initiate their own EN pins low). Focusing on example 302, when EN1 is asserted or high, regulator 101 can output VOUT1 and its PG1 pin can enable regulator 102 by pulling up EN2. When EN2 is asserted or high, regulator 102 can output VOUT2 and its PG2 pin can enable regulator 103 by pulling up EN2, causing output of VOUT3 from regulator 103. When EN1 is de-asserted or low, VOUT1 from regulator 101 also falls to low, and sequentially causing VOUT2 and VOUT3 to fall as well and shutting down all downstream devices. Focusing on example 304, when EN1 remains high and a fault occurs in regulator 102 causing VOUT2 to fall to low, downstream device regulator 103 is disabled as shown by VOUT3 falling to low, but VOUT1 remains high and controller 110 would need to be notified to pull EN1 low to disable regulator 101.

In an example 312 and example 314 shown in FIG. 3B, regulator 101 is configured as the third type of power rail (e.g., master regulator) and regulators 102, 103 are configured as the second type of power rails (e.g., being able to initiate their own EN pins low). Focusing on example 312, when EN1 at the master regulator is de-asserted or low, VOUT1 from regulator 101 also falls to low, and the output voltages of other regulators (e.g., VOUT2, VOUT3) can be pulled low either synchronously (e.g., at the same time) or in an arbitrary order. For example, the output voltages of the downstream regulators can be held for some time to perform a synchronized system-wide shut down. In one embodiment, each regulator can include internal registers storing a predefine synchronized shutdown time that can result in a synchronized system-wide shut down. In example 314, when EN1 remains high and a fault occurs in regulator 102 causing VOUT2 to fall to low, both upstream regulator 101 and downstream regulator 103 are disable as shown by VOUT1 and VOUT3 falling to low at the same time despite EN1 remaining high. Hence, the systems described in the present disclosure can allow slave regulators to shut down upstream devices while also providing flexibility in downstream shutdown schemes.

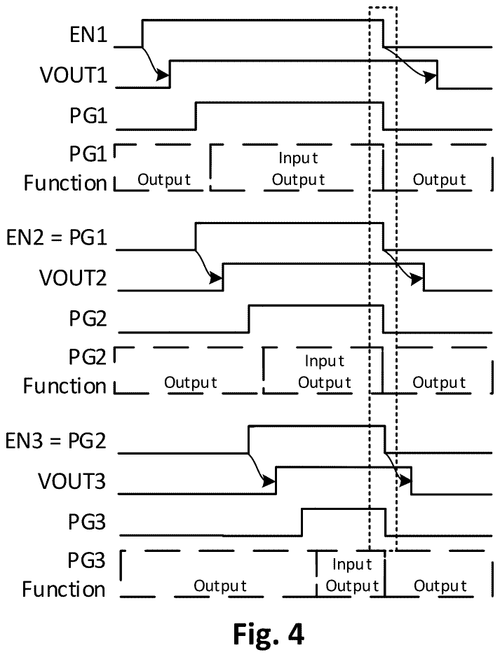

FIG. 4 is a diagram showing example signals of an implementation of autonomous system sequencing of discrete regulators with cascaded interface signal in one embodiment. Descriptions of FIG. 4 can reference components shown in FIG. 1 and FIG. 2. In the example shown in FIG. 4, when EN1 goes rises to high, VOUT1 rises to high after some delay and PG1 is asserted by rising to high as well. After PG1 is asserted, the PG1 pin can function as both input and output pin. When PG1 is asserted, EN2 is also asserted, which causes VOUT2 and PG2 to rise. After PG2 is asserted, the PG2 pin can function as both input and output pin. When PG2 is asserted, EN3 is also asserted, which causes VOUT3 and PG3 to rise. After PG3 is asserted, the PG3 pin can function as both input and output pin. When EN1 goes low, PG1 will also de-assert and fall to low but VOUT1 is being held as high for some delay. PG1 falling can pull down EN2, causing PG2 to de-assert and also pull down EN3 to de-asset PG3. The EN1, PG1, EN2, PG2, EN3, PG3 can fall to low at approximately the same time, and the output voltages VOUT1, VOUT2, VOUT3 can be held high for the same or different delays depending on the application of system 100. For example, comparing to example 312 shown in FIG. 3B, the output voltages in example 312 falls together but the output voltages in FIG. 4 fall at different times depending on different predefined delays being stored in the internal registers of the regulators.

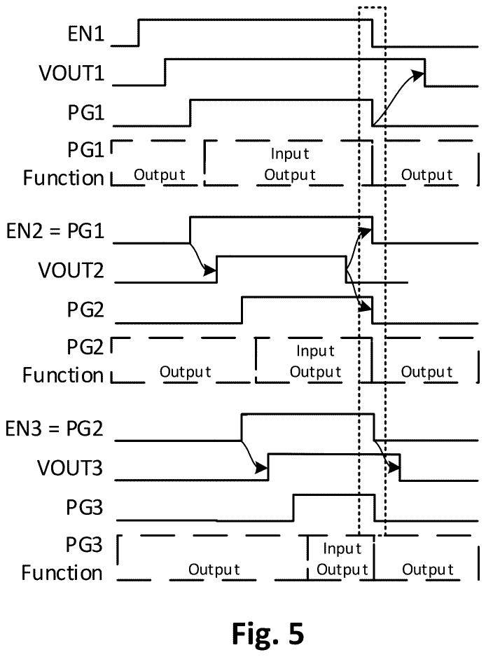

FIG. 5 is a diagram showing example signals of another implementation of autonomous system sequencing of discrete regulators with cascaded interface signal in one embodiment. Descriptions of FIG. 4 can reference components shown in FIG. 1 and FIG. 2. In the example shown in FIG. 5, when EN1 goes rises to high, VOUT1 rises to high after some delay and PG1 is asserted by rising to high as well. After PG1 is asserted, the PG1 pin can function as both input and output pin. When PG1 is asserted, EN2 is also asserted, which causes VOUT2 and PG2 to rise. After PG2 is asserted, the PG2 pin can function as both input and output pin. When PG2 is asserted, EN3 is also asserted, which causes VOUT3 and PG3 to rise. After PG3 is asserted, the PG3 pin can function as both input and output pin. When VOUT2 falls to low as a result of a fault condition in regulator 102, EN2 goes low and pulls down both PG1 and PG2, which also causes EN3 and PG3 to fall to low. The EN1, PG1, EN2, PG2, EN3, PG3 can fall to low at approximately the same time, and the output voltages VOUT1 and VOUT3 can be held high for the same or different delays depending their respective regulator's predefined delays to hold output voltage. Comparing to example 314 shown in FIG. 3B, the output voltages VOUT1 and VOUT3 in example 314 falls together but in FIG. 4, they fall at different times depending on different predefined delays being stored in the internal registers of the regulators 101, 103.

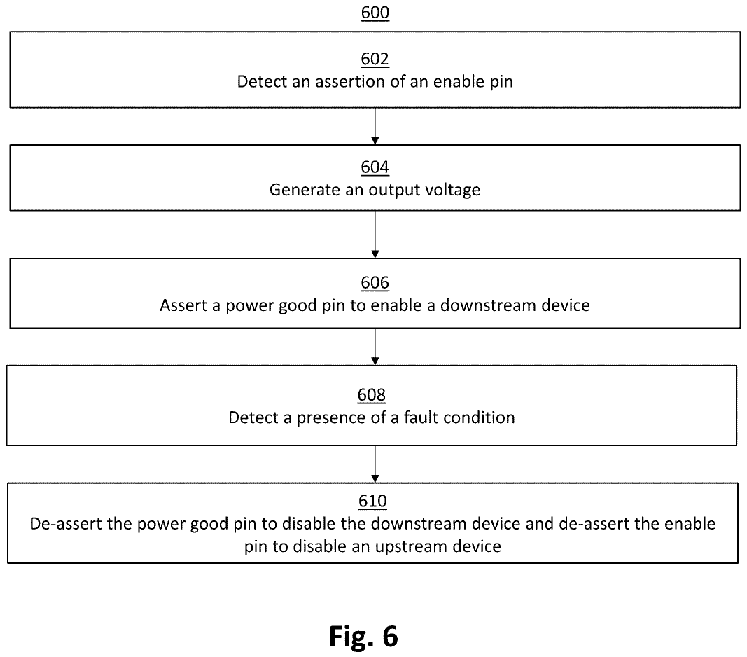

FIG. 6 is a flowchart of an example process 600 that can implement autonomous system sequencing of discrete regulators with cascaded interface signal in one embodiment. Descriptions of FIG. 6 may reference components shown in FIGS. 1-5. The process 600 can include one or more operations, actions, or functions as illustrated by one or more of blocks 602, 604, 606, 608, and 610. Although illustrated as discrete blocks, various blocks can be divided into additional blocks, combined into fewer blocks, eliminated, performed in different order, or performed in parallel, depending on the desired implementation.

Process 600 can be performed by a regulator described herein, such as one of the regulators in system 100 described in the present disclosure. Process 600 can begin at block 602. At block 602, the regulator can detect an assertion of an enable pin. Process 600 can proceed from block 602 to block 604. At block 604, in response to detecting the assertion of the enable pin, the regulator can generate an output voltage. Process 600 can proceed from block 604 to block 606. At block 606, in response to the output voltage reaching a predefined voltage level, the regulator can assert a power good pin to enable a downstream device. Process 600 can proceed from block 606 to block 608. At block 608, the regulator can detect a presence of a fault condition. Process 600 can proceed from block 608 to block 610. At block 610, in response to detecting the fault condition, the regulator can de-assert the power good pin to disable the downstream device and de-assert the enable pin to disable an upstream device.

In one embodiment, the regulator can include a switch connected between the enable pin and ground. In response to detecting the fault condition, the regulator can de-assert the enable pin by turning on the switch to pull down a voltage at the enable pin. In one embodiment, the regulator can further include a resistor connected between the switch the enable pin. An amount of voltage being pulled down can be based on a resistance of the resistor and the amount of voltage being pulled down can be indicative of a type of the fault condition. In one embodiment, the resistance of the resistor can be variable.

In one embodiment, the regulator can configure the power good pin as an input pin for detecting de-assertion of a downstream enable pin of a downstream device. In one embodiment, the regulator can detect a de-assertion of the power good pin caused by the de-assertion of the downstream enable pin of the downstream device. In response to detecting the de-assertion of the power good pin, the regulator can de-assert the enable pin to disable the upstream device. In one embodiment, the detection of the de-assertion of the power good pin caused by the de-assertion of the downstream enable pin of the downstream device can include detecting a voltage at the power good pin is less than a reference power good voltage.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Examples

### Example 1

An apparatus comprising: an enable pin configured to receive an enable signal for enabling generation of an output voltage; a power good pin configured to output a power good signal indicating a status of the output voltage; a circuit configured to: detect a presence of a fault condition; in response to detecting the fault condition: de-assert the power good pin to disable a downstream device; and de-assert the enable pin to disable an upstream device.

### Example 2

The apparatus of Example 1, wherein: the circuit comprises a switch connected between the enable pin and ground; and in response to detecting the fault condition, the circuit is configured to de-assert the enable pin by turning on the switch to pull down a voltage at the enable pin.

### Example 3

The apparatus of Example 1 or Example 2, wherein: the circuit further comprising a resistor connected between the switch the enable pin; an amount of voltage being pulled down is based on a resistance of the resistor; and the amount of voltage being pulled down is indicative of a type of the fault condition.

### Example 4

The apparatus of any one of Examples 1 to 3, wherein the resistance of the resistor is variable.

### Example 5

The apparatus of any one of Examples 1 to 4, wherein the circuit is configured to configure the power good pin as an input pin for detecting de-assertion of a downstream enable pin of a downstream device.

### Example 6

The apparatus of any one of Examples 1 to 5, wherein the circuit is further configured to: detect a de-assertion of the power good pin caused by the de-assertion of the downstream enable pin of the downstream device; and in response to detecting the de-assertion of the power good pin, de-assert the enable pin to disable the upstream device.

### Example 7

The apparatus of any one of Examples 1 to 6, wherein detection of the de-assertion of the power good pin caused by the de-assertion of the downstream enable pin of the downstream device comprises detecting a voltage at the power good pin is less than a reference power good voltage.

### Example 8

A system comprising: a plurality of voltage regulators including at least an upstream voltage regulator, a specific voltage regulator, and a downstream voltage regulator, wherein the specific voltage regulator comprises: an enable pin configured to receive an enable signal from the upstream voltage regulator for enabling the specific voltage regulator; a power good pin configured to output a power good signal to control an enable pin of the downstream voltage regulator; a circuit configured to: detect a presence of a fault condition in the specific voltage regulator; in response to detecting the fault condition: de-assert the power good pin to disable the downstream voltage regulator; and de-assert the enable pin to disable the upstream voltage regulator.

### Example 9

The system of Example 8, wherein: the circuit comprises a switch connected between the enable pin and ground; and in response to detecting the fault condition, the circuit is configured to de-assert the enable pin by turning on the switch to pull down a voltage at the enable pin.

### Example 10

The system of Example 8 or Example 9, wherein: the circuit further comprising a resistor connected between the switch the enable pin; an amount of voltage being pulled down is based on a resistance of the resistor; and the amount of voltage being pulled down is indicative of a type of the fault condition.

### Example 11

The system of any one of Examples 8 to 10, wherein the resistance of the resistor is variable.

### Example 12

The system of any one of Examples 8 to 11, wherein the circuit is configured to configure the power good pin as an input pin for detecting de-assertion of the enable pin of the downstream voltage regulator.

### Example 13

The system of any one of Examples 8 to 12, wherein the circuit is further configured to: detect a de-assertion of the power good pin caused by the de-assertion of the enable pin of the downstream voltage regulator; and in response to detecting the de-assertion of the power good pin, de-assert the enable pin to disable the upstream voltage regulator.

### Example 14

The system of any one of Examples 8 to 13, wherein detection of the de-assertion of the power good pin caused by the de-assertion of the enable pin of the downstream voltage regulator comprises detecting a voltage at the power good pin is less than a reference power good voltage.

### Example 15

A system comprising: a plurality of voltage regulators; and a controller configured to enable a first voltage regulator among the plurality of voltage regulators, wherein: the plurality of voltage regulators include at least the first voltage regulator and a second voltage regulator; the first voltage regulator comprises: a first enable pin configured to receive an enable signal from the controller for enabling the first voltage regulator; a first power good pin configured to output a first power good signal to control a second enable pin of the second voltage regulator;
and a first circuit configured to configure the first power good pin as an input pin for detecting de-assertion of the second enable pin of the second voltage regulator; the second voltage regulator comprises: a second enable pin configured to receive the first power good signal from the first power good pin; a second power good pin configured to output a second power good signal to control a downstream voltage regulator among the plurality of voltage regulators; and a second circuit configured to: configure the second power good pin as an input pin for detecting de-assertion of an enable pin of the downstream voltage regulator; detect a presence of a fault condition in the second voltage regulator; in response to detecting the fault condition: de-assert the second power good pin to disable the downstream voltage regulator; and de-assert the second enable pin to disable the first voltage regulator.

### Example 16

The system of Example 15, wherein: the second circuit comprises a switch connected between the enable pin and ground; and in response to detecting the fault condition, the second circuit is configured to de-assert the enable pin by turning on the switch to pull down a voltage at the enable pin.

### Example 17

The system of Example 15 or Example 16, wherein: the second circuit further comprising a resistor connected between the switch the enable pin; an amount of voltage being pulled down is based on a resistance of the resistor; and the amount of voltage being pulled down is indicative of a type of the fault condition.

### Example 18

the System of Any One of Examples 15 to 17, Wherein the Resistance of the resistor is variable.

### Example 19

The system of any one of Examples 15 to 18, wherein the second circuit is further configured to: detect a de-assertion of the second power good pin caused by the de-assertion of the enable pin of the downstream voltage regulator; and in response to detecting the de-assertion of the second power good pin, de-assert the second enable pin to disable the first voltage regulator.

### Example 20

The system of any one of Examples 15 to 19, wherein detection of the de-assertion of the second power good pin caused by the de-assertion of the enable pin of the downstream voltage regulator comprises detecting a voltage at the second power good pin is less than a reference power good voltage.

The terminology used herein is for the purpose of describing particular embodiments

only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus

function elements, if any, in the claims below are intended to include any structure, material, or act for performing the function in combination with other claimed elements as specifically claimed. The disclosed embodiments of the present disclosure have been presented for purposes of illustration and description but are not intended to be exhaustive or limited to the present disclosure in the forms disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

What is claimed is:

1. An apparatus comprising:
an enable pin configured to receive an enable signal for enabling generation of an output voltage;
a power good pin configured to output a power good signal indicating a status of the output voltage; and
a circuit configured to:
detect a presence of a fault condition; and
in response to detecting the fault condition:
de-assert the power good pin to disable a downstream device; and
de-assert the enable pin to disable an upstream device.

2. The apparatus of claim 1, wherein:
the circuit comprises a switch connected between the enable pin and ground; and
in response to detecting the fault condition, the circuit is configured to de-assert the enable pin by turning on the switch to pull down a voltage at the enable pin.

3. The apparatus of claim 2, wherein:
the circuit further comprising a resistor connected between the switch the enable pin;
an amount of voltage being pulled down is based on a resistance of the resistor; and
the amount of voltage being pulled down is indicative of a type of the fault condition.

4. The apparatus of claim 3, wherein the resistance of the resistor is variable.

5. The apparatus of claim 1, wherein the circuit is configured to configure the power good pin as an input pin for detecting de-assertion of a downstream enable pin of a downstream device.

6. The apparatus of claim 5, wherein the circuit is further configured to:
detect a de-assertion of the power good pin caused by the de-assertion of the downstream enable pin of the downstream device; and
in response to detecting the de-assertion of the power good pin, de-assert the enable pin to disable the upstream device.

7. The apparatus of claim 6, wherein detection of the de-assertion of the power good pin caused by the de-assertion of the downstream enable pin of the downstream device comprises detecting a voltage at the power good pin is less than a reference power good voltage.

8. A system comprising:
a plurality of voltage regulators including at least an upstream voltage regulator, a specific voltage regulator, and a downstream voltage regulator, wherein the specific voltage regulator comprises:
an enable pin configured to receive an enable signal from the upstream voltage regulator for enabling the specific voltage regulator;
a power good pin configured to output a power good signal to control an enable pin of the downstream voltage regulator; and
a circuit configured to:
detect a presence of a fault condition in the specific voltage regulator; and
in response to detecting the fault condition:
de-assert the power good pin to disable the downstream voltage regulator; and
de-assert the enable pin to disable the upstream voltage regulator.

9. The system of claim 8, wherein:
the circuit comprises a switch connected between the enable pin and ground; and
in response to detecting the fault condition, the circuit is configured to de-assert the enable pin by turning on the switch to pull down a voltage at the enable pin.

10. The system of claim 9, wherein:
the circuit further comprising a resistor connected between the switch the enable pin;
an amount of voltage being pulled down is based on a resistance of the resistor; and
the amount of voltage being pulled down is indicative of a type of the fault condition.

11. The system of claim 10, wherein the resistance of the resistor is variable.

12. The system of claim 8, wherein the circuit is configured to configure the power good pin as an input pin for detecting de-assertion of the enable pin of the downstream voltage regulator.

13. The system of claim 12, wherein the circuit is further configured to:
detect a de-assertion of the power good pin caused by the de-assertion of the enable pin of the downstream voltage regulator; and
in response to detecting the de-assertion of the power good pin, de-assert the enable pin to disable the upstream voltage regulator.

14. The system of claim 13, wherein detection of the de-assertion of the power good pin caused by the de-assertion of the enable pin of the downstream voltage regulator comprises detecting a voltage at the power good pin is less than a reference power good voltage.

15. A system comprising:
a plurality of voltage regulators; and
a controller configured to enable a first voltage regulator among the plurality of voltage regulators, wherein:
the plurality of voltage regulators include at least the first voltage regulator and a second voltage regulator;
the first voltage regulator comprises:
a first enable pin configured to receive an enable signal from the controller for enabling the first voltage regulator;
a first power good pin configured to output a first power good signal to control a second enable pin of the second voltage regulator; and
a first circuit configured to configure the first power good pin as an input pin for detecting de-assertion of the second enable pin of the second voltage regulator; and
the second voltage regulator comprises:
a second enable pin configured to receive the first power good signal from the first power good pin;
a second power good pin configured to output a second power good signal to control a downstream voltage regulator among the plurality of voltage regulators; and
a second circuit configured to:
configure the second power good pin as an input pin for detecting de-assertion of an enable pin of the downstream voltage regulator;
detect a presence of a fault condition in the second voltage regulator; and
in response to detecting the fault condition:
de-assert the second power good pin to disable the downstream voltage regulator; and
de-assert the second enable pin to disable the first voltage regulator.

16. The system of claim 15, wherein:
the second circuit comprises a switch connected between the enable pin and ground; and
in response to detecting the fault condition, the second circuit is configured to de-assert the enable pin by turning on the switch to pull down a voltage at the enable pin.

17. The system of claim 16, wherein:
the second circuit further comprising a resistor connected between the switch the enable pin;
an amount of voltage being pulled down is based on a resistance of the resistor; and
the amount of voltage being pulled down is indicative of a type of the fault condition.

18. The system of claim 17, wherein the resistance of the resistor is variable.

19. The system of claim 15, wherein the second circuit is further configured to:
detect a de-assertion of the second power good pin caused by the de-assertion of the enable pin of the downstream voltage regulator; and
in response to detecting the de-assertion of the second power good pin, de-assert the second enable pin to disable the first voltage regulator.

20. The system of claim 19, wherein detection of the de-assertion of the second power good pin caused by the de-assertion of the enable pin of the downstream voltage regulator comprises detecting a voltage at the second power good pin is less than a reference power good voltage.
